(19) United States
(12) Patent Application Publication
(10) Pub. No.: US 2010/0171889 A1
(43) Pub. Date: Jul. 8, 2010

(54) WEATHER-RESISTANT DISPLAY

(76) Inventors: Joseph Pantel, Garden Grove, CA (US); Liao Chun Chi, Neihu District (TW)

Correspondence Address: EVAN LAW GROUP LLC, 600 WEST JACKSON BLVD., SUITE 625, CHICAGO, IL, 60661, US

(21) Appl. No.: 12/349,225

(22) Filed: Jan. 6, 2009

(51) Int. Cl. G02F 1/13; G02F 1/1333; G02F 1/133

(52) U.S. Cl. 349/1; 349/58; 349/72; 349/116; 349/137

(57) ABSTRACT

An outdoor weather-resistant display may include a housing, an air-inlet, an air-outlet, a liquid crystal panel, a fan, and a thermostat. The air-inlet may be disposed through the housing into a cavity. The air-outlet may be disposed through the housing out of the cavity. The fan may be positioned to move air from outside the housing, through the air-inlet, into the cavity, across the liquid crystal panel, and out of the cavity through the air-outlet to outside the housing. The thermostat may have a temperature sensor within the cavity which provides temperature readings. The thermostat may control operation of the fan based on the temperature readings in order to regulate temperature within the cavity. The outdoor weather-resistant display may have further components to allow the display to operate in varying weather conditions, and to allow for wireless operation.

### FIELD OF THE DISCLOSURE

The disclosure relates to displays, and more specifically, to weather-resistant displays for outdoor use.

### BACKGROUND OF THE DISCLOSURE

Many conventional displays, such as liquid crystal displays, are not weather-resistant and therefore are not suited to operate outside in varying outdoor weather conditions, which includes various precipitation such as rain, snow, and hail; various temperature ranges such as in excess of 40° C. and below 0° C.; and various amounts of ambient light. Exposing these displays to extreme temperature conditions, moisture, and other weather-related elements may damage the displays. Other displays which are weather-resistant may have varying types of problems. Some of these displays may not generate a bright enough image for viewing in direct sunlight. Other displays may not be adapted to receive and transmit audio and video signals wirelessly. Additional displays may not be adapted to automatically change the brightness of the image displayed by the display, also known herein as the viewing picture, to accommodate for changing ambient light conditions. Still other displays reflect too much ambient light, making it difficult for the user to view the viewing picture. Further displays may suffer from additional types of problems.

It would be desirable to have a weather-resistant display to reduce and/or solve one or more problems of one or more of the conventional displays.

### SUMMARY OF THE DISCLOSURE

In one aspect of the disclosure, an outdoor weather-resistant display may comprise a housing, an air-inlet, an air-outlet, a liquid crystal panel, a fan, and a thermostat. The housing may define a cavity. The air-inlet may be disposed through the housing into the cavity. The air-outlet may be disposed through the housing out of the cavity. The liquid crystal panel may be disposed within the cavity. The fan may be positioned to move air from outside the housing, through the air-inlet, into the cavity, across the liquid crystal panel, and out of the cavity through the air-outlet to outside the housing. The thermostat may have a temperature sensor within the cavity. The temperature sensor may provide temperature readings within the cavity to the thermostat. The thermostat may be in communication with the fan. The thermostat may control operation of the fan based on the temperature readings in order to regulate temperature within the cavity.

In another aspect of the disclosure, an outdoor weather-resistant display may comprise a glass panel, an anti-reflective coating, a liquid crystal panel, a brightness-enhancing diffusing film, and a backlight. The glass panel may comprise a front viewing surface and a back surface. An anti-reflective coating may cover the front viewing surface of the glass panel. The liquid crystal panel may be disposed behind the back surface of the glass panel. The brightness-enhancing diffusing film may be disposed behind the liquid crystal panel. The backlight may be disposed behind the brightness-enhancing diffusing film.

In another aspect of the disclosure, an outdoor weather-resistant display may comprise a liquid crystal panel, a backlight, and a photocell. The backlight may be disposed behind the liquid crystal panel. The photocell may be in communication with the backlight for brightening the backlight when an amount of ambient light around the display is increased and dimming the backing when the amount of ambient light around the display is decreased.

In another aspect of the disclosure, an outdoor weather-resistant display may comprise a liquid crystal panel, and an infrared repeater. The infrared repeater may be for receiving an infrared signal and communicating the infrared signal to an external electronic component at a remote location.

In another aspect of the disclosure, an outdoor weather-resistant display may comprise a housing and a liquid crystal panel. The housing may be made of a metal having a thermal conductivity of at least 200 W/mK. The liquid crystal panel may be disposed within a cavity of the housing.

In another aspect of the disclosure, an outdoor weather-resistant display may comprise a liquid crystal panel, and a wireless device. The wireless device may comprise a receiver for wirelessly receiving audio and video signals transmitted from an external electronic component.

In another aspect of the disclosure, an outdoor weather-resistant display may comprise a housing, a liquid crystal panel, and a circuit board. The housing may define a cavity. The liquid crystal panel and the circuit board may be disposed within the cavity. The circuit board may be coated with a weather-resistant coating.

In another aspect of the disclosure, an outdoor weather-resistant display may comprise a housing and a liquid crystal panel disposed within a cavity of the housing. The housing may comprise a front viewing surface and an opposing back surface, a top surface and an opposing bottom surface, and two side surfaces. The top surface, the bottom surface, and the two side surfaces may extend between the front viewing surface and the back surface. At least one of the top surface and the two side surfaces may be angled towards the back surface at an angle of more than 90 degrees relative to a plane extending through the front viewing surface in order to move moisture away from the front viewing surface.

In another aspect of the disclosure, an outdoor weather-resistant display may comprise a housing, an electrical connector, a removable panel, and a liquid crystal panel. The housing may comprise an external housing surface. A first cavity may be defined in the external housing surface. The first cavity may comprise an internal cavity surface which is recessed behind the external housing surface. The electrical connector may be disposed on the internal recessed cavity surface. The removable panel may be for covering the first cavity. The liquid crystal panel may be disposed within a second cavity of the housing.

In another aspect of the disclosure, an outdoor weather-resistant display may comprise a front housing, a back housing, a liquid crystal panel, a fan, a thermostat, a glass panel, and a circuit board. The front housing may be sealed to the back housing with a first sealant. A cavity may be defined within the front and back sealed housings. The liquid crystal panel may be disposed within the cavity. The fan may be positioned to move air from outside the front and back sealed housings, through an air-inlet, into the cavity, across the liquid crystal panel, and out of the cavity to outside the front and back sealed housings. The thermostat may have a temperature sensor within the cavity. The temperature sensor may provide temperature readings within the cavity to the thermostat. The thermostat may be in communication with the fan. The thermostat may control operation of the fan based on the temperature readings in order to regulate temperature within the cavity. The glass panel may cover the cavity. The glass panel may be sealed to the front housing with a second sealant. The circuit board may be disposed within the cavity. The circuit board may be coated with a weather-resistant coating.

These and other features, aspects and advantages of the disclosure will become better understood with reference to the following drawings, description and claims. The scope of the present invention is defined solely by the appended claims and is not affected by the statements within this summary.

### BRIEF DESCRIPTION OF THE DRAWINGS

FIG. 1 is a right front perspective view of one embodiment of an outdoor weather-resistant display;

FIG. 2 is a partially exploded cross-section view through line 2-2 of the outdoor weather-resistant display of FIG. 1;

FIG. 3 is a partial cross-sectional view through line 3-3 of the outdoor weather-resistant display of FIG. 1;

FIG. 4 is a back perspective view of the outdoor weather-resistant display of FIG. 1;

FIG. 5 is a left side view of the outdoor weather-resistant display of FIG. 1;

FIG. 6 is a right side view of the outdoor weather-resistant display of FIG. 1;

FIG. 7 is a partially exploded bottom view of the outdoor weather-resistant display of FIG. 1;

FIG. 8 is a partially exploded back perspective view of the outdoor weather-resistant display of FIG. 1 with a removable panel removed to show a recessed electrical connector cavity;

FIG. 9 is a partial cross-sectional view through line 9-9 of the outdoor weather-resistant display of FIG. 8;

FIG. 10 is a partially exploded front perspective view of the outdoor weather-resistant display of FIG. 1;

FIG. 11 is a cross-sectional view through line 11-11 of the outdoor weather-resistant display of FIG. 1 showing the assembled arrangement of components within an internal cavity of the housing; and

FIG. 12 is a front perspective view of the outdoor weather-resistant display of FIG. 1 communicating with an external electronic component located at a remote location.

### DETAILED DESCRIPTION OF THE DISCLOSURE

The following detailed description is of the best currently contemplated modes of carrying out the disclosure. The description is not to be taken in a limiting sense, but is made merely for the purpose of illustrating the general principles of the disclosure, since the scope of the disclosure is best defined by the appended claims.

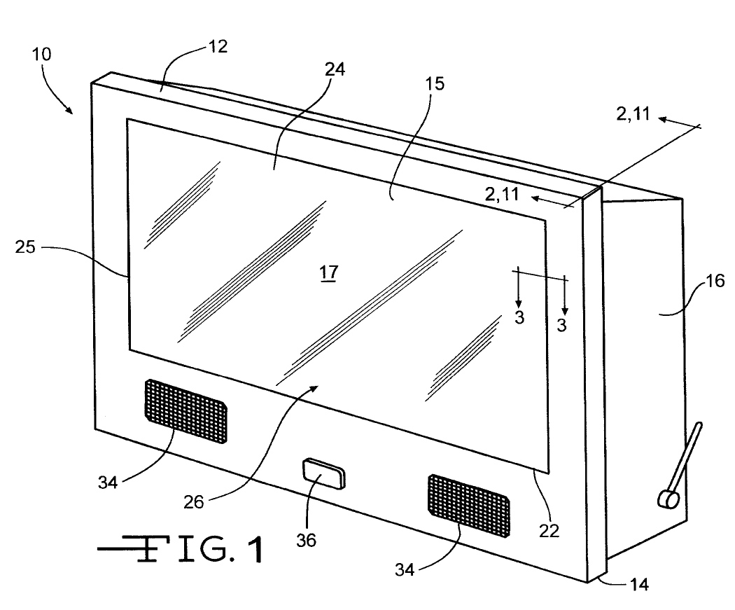

FIG. 1 is a right front perspective view of one embodiment of an outdoor weather-resistant display 10. The outdoor weather-resistant display 10 may comprise a liquid crystal display for viewing a picture and listening to audio. Preferably, the outdoor weather-resistant display 10 is resistant to outdoor weather conditions and includes components which aid in this effect. The outdoor weather-resistant display 10 may comprise a housing 12. The housing 12 may be made of a material having a high thermal conductivity in order to efficiently transfer heat from the display 10 to the atmosphere. Preferably, the housing 12 is made of a metal having a thermal conductivity of at least 200 W/mK, such as a powder-coated Aluminum. In other embodiments, the housing 12 may be made of or include varying high thermal conductivity materials, such as gold, silver, and/or copper, and may be made using varying processes. The housing 12 may comprise a front housing 14 attached to a back housing 16. The front housing 14 may comprise a front viewing surface 15.

The front viewing surface 15 of the housing 12 may comprise a glass panel 24 attached to surfaces 25 of a cavity 26 in the front housing 14. The glass panel 24 may be made of any type of clear material, such as: acrylic glass made from Poly(methyl methacrylate) (PMMA) or poly(methyl 2-methylpropenoate), soda-lime glass, borosilicate glass, sugar glass, isinglass (Muscovy-glass), aluminium oxynitride, and tempered glass. The glass panel 24 may be shatter-resistant to resist the likelihood of the glass panel shattering 24. If the glass panel 24 does shatter, the glass panel may be designed to shatter into dull pieces to reduce the likelihood of a person being injured. The glass panel 24 may comprise a front viewing surface 17 and a back surface 19. The glass panel 24 may have an anti-reflective coating 26 on the front viewing surface 17 of the glass panel 24. Preferably, the anti-reflecting coating is applied using a sputtering process, a spin coating process, or chemical dipping, wherein a thin layer of anti-reflective material is applied to the viewing surface of the glass panel 24. Preferably, anti-reflective coating 26 comprises materials such as magnesium fluoride, MgF₂ (having an index of refraction of 1.38), and fluoropolymers (having an index of refraction as low as 1.30), SiO₂, and TiO₂. Preferably, the anti-reflective coating 26 has a thickness 27 of preferably less than 100 microns, and more preferably less than ten microns. In one embodiment, the anti-reflective coating 26 comprises both SiO₂ and TiO₂. In one embodiment, the antireflective coating is manufactured by YIH DAR of Taiwan, having a website located at WWW.YDTECH.COM.TW. The anti-reflective coating 26 may comprises multiple layers of materials, wherein each layers contains the same or different materials from the other layers. In other embodiments, glass panel 24 and the anti-reflective coating 26 may vary. The front housing 14 may be defined by a plurality of speaker openings 34. The speaker openings 34 may be slotted and/or in other configurations. The front housing 14 may be further defined by a repeater/photocell opening 36.

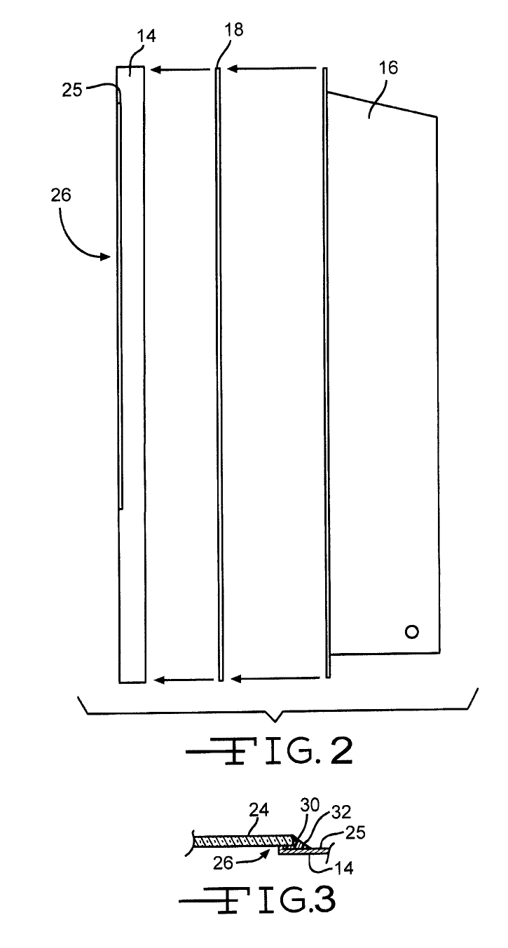

FIG. 2 is a partially exploded cross-sectional view through line 2-2 of the display of FIG. 1. As shown in FIG. 2, the front housing 14 may be sealed to the back housing 16 with a first sealant 18. The first sealant 18 may comprise a gasket made from rubber, a polymer such as plastic, or any other flexible material. The first sealant may also comprise a material which is sprayed on or applied, such as a glue, an epoxy, or silicone. The first sealant 18 may also be an acrylic sealant, a butyl sealant, a latex sealant, a polysulfide sealant, a polyurethane sealant, or a silicone sealant. Preferably, the first sealant 18 comprises a rubber gasket so as to make it replaceable and so as to allow for the housing to be opened and closed without having to replace first sealant 18. Preferably, the first sealant 18 is ring-shaped and extends around the entire perimeter 22 of the display 10 in between the front housing 14 and the back housing 16 in order to fully seal the front housing 14 to the back housing 16. When the housing 12 is closed, the first sealant 18 is pressed between both the front and back housings 14, 16 so as to compress the first sealant 18, in order to prevent foreign matters, such as liquid and dust particles, from entering the housing 12. In this manner, the first sealant 18 may substantially resist and/or prevent moisture from penetrating the display 10. In other embodiments, the first sealant 18 may vary.

FIG. 3 is a partial cross-sectional view through line 3-3 of FIG. 1. As shown in FIG. 3, a perimeter 30 of the glass panel 24 may be sealed to the surfaces 25 of the cavity 26 of the front housing 14 with a second sealant 32. The second sealant 32 may comprise an acrylic sealant, a butyl sealant, a latex sealant, a polysulfide sealant, a polyurethane sealant, or a silicone sealants. The second sealant 32 at least partially or completely fills the area between the glass panel 24 and the surfaces 25 of the front housing 14, so as to substantially resist and/or prevent moisture from penetrating the display 10. In other embodiments, the second sealant 32 may vary.

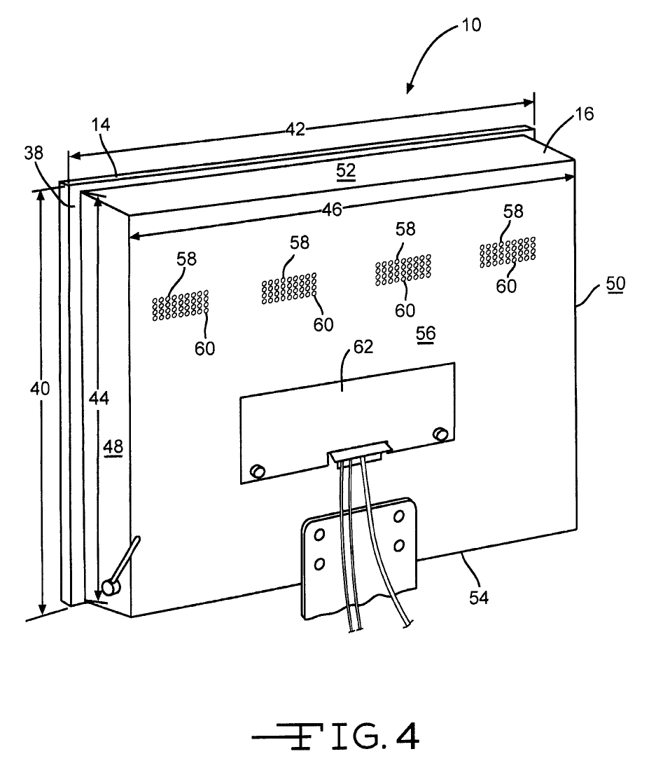

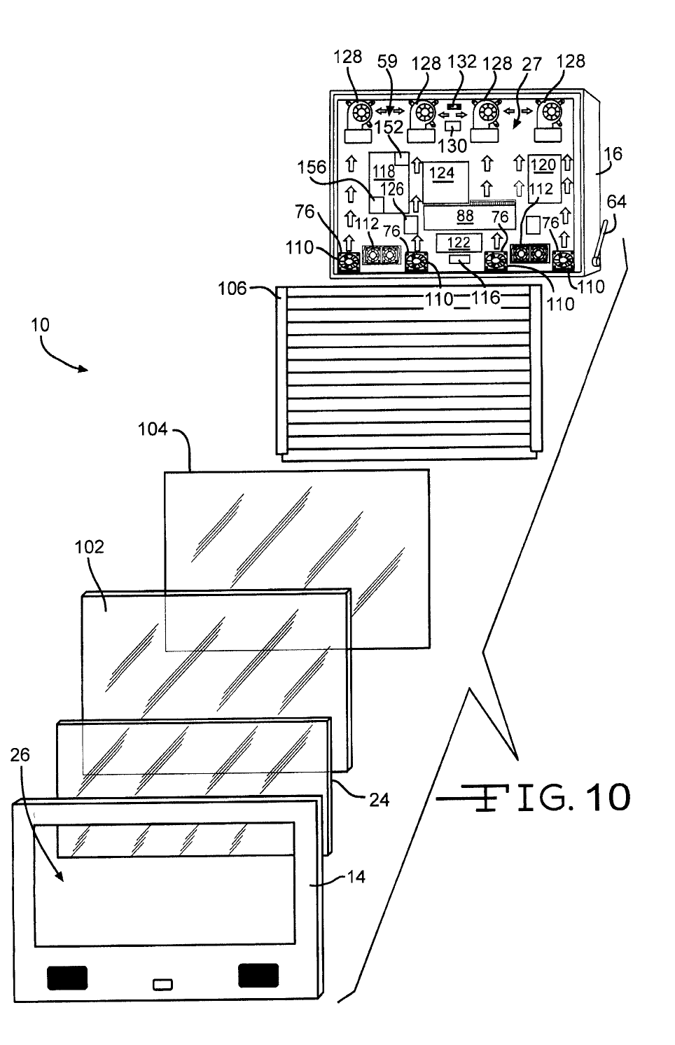

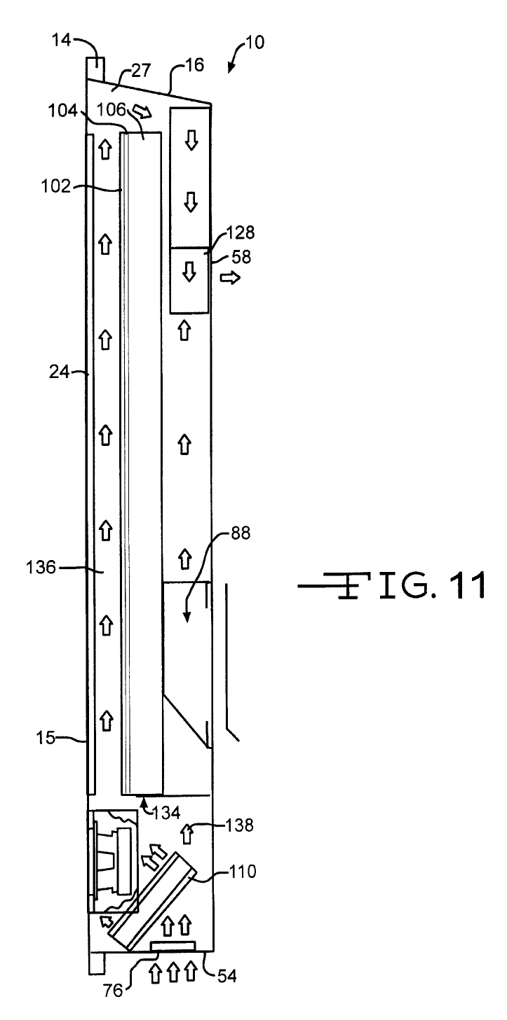

FIG. 4 shows a back perspective view of the display 10. The front housing 14 may comprise a flat surface 38 having a larger height 40 and width 42 than the height 44 and width 46 of the back housing 16. The back housing 16 may comprise left and right side opposing surfaces 48 and 50, top and bottom opposing surfaces 52 and 54, and back surface 56. An open front 59 (shown in FIG. 10) of the back housing 16 may be covered by the surface 38 of the front housing 14. The back surface 56 may form air-outlets 58 extending from a cavity 27 (shown in FIG. 10) of the back housing 16 and out of the back housing 16. The air-outlets 58 may comprise a plurality of closely-spaced openings 60. Preferably, the air-outlets 58 are disposed close to the top surface 52 and above any electrical circuitry, such as PCB image board 124. In other embodiments, the air-outlets 58 may be disposed in or adjacent to the top surface 52. In still other embodiments, the position of the air-outlets 58 may vary. A removable panel 62 may be attached to the back surface 56.

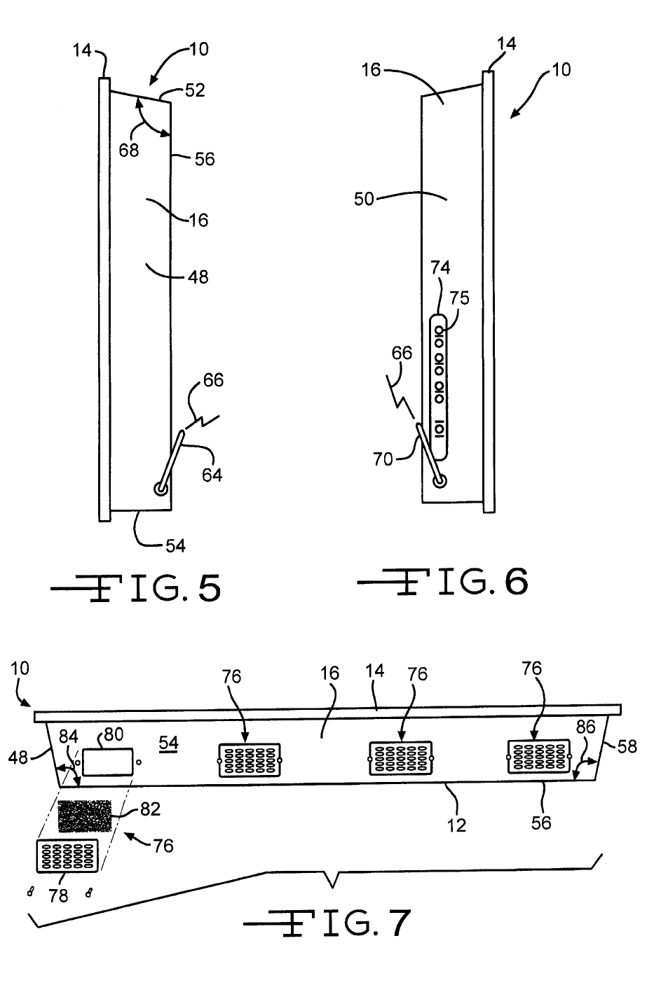

FIG. 5 is a left side view of the display 10. An antenna 64 may be attached to the left side surface 48. The antenna 64 may be adapted to transmit and/or receive radio frequency signals 66. The top surface 52 may be angled at an angle 68 towards the back surface 56. The angle 68 may extend between a plane 69 formed in the front viewing surface 15 of the front housing 12 and the top surface 52. The angle 68 may be greater than 90 degrees. In another embodiment, the angle 68 is from 95 degrees to 170 degrees, and preferably, 105 degrees to 160 degrees, and more preferably from 105 to 135 degrees. The angle 68 may allow for moisture to be moved away from the front viewing surface 15 towards the back surface 56 to limit moisture accumulation over the front viewing surface 15. The bottom surface 54 may be perpendicular to the front viewing surface 15 and to the back surface 56.

FIG. 6 is a right side view of the display 10. An antenna 70 may be attached to the right side surface 50. The antenna 70 may be adapted to transmit and/or receive radio frequency signals 66. Display controllers 74 may be disposed on the right side surface 50. The display controllers 74 may be adapted to control one or more settings of the display 10 such as a volume setting, a channel setting, a display setting, and/or another type of setting. The display controllers 74 may comprise buttons 75, knobs, levers, or other controlling devices.

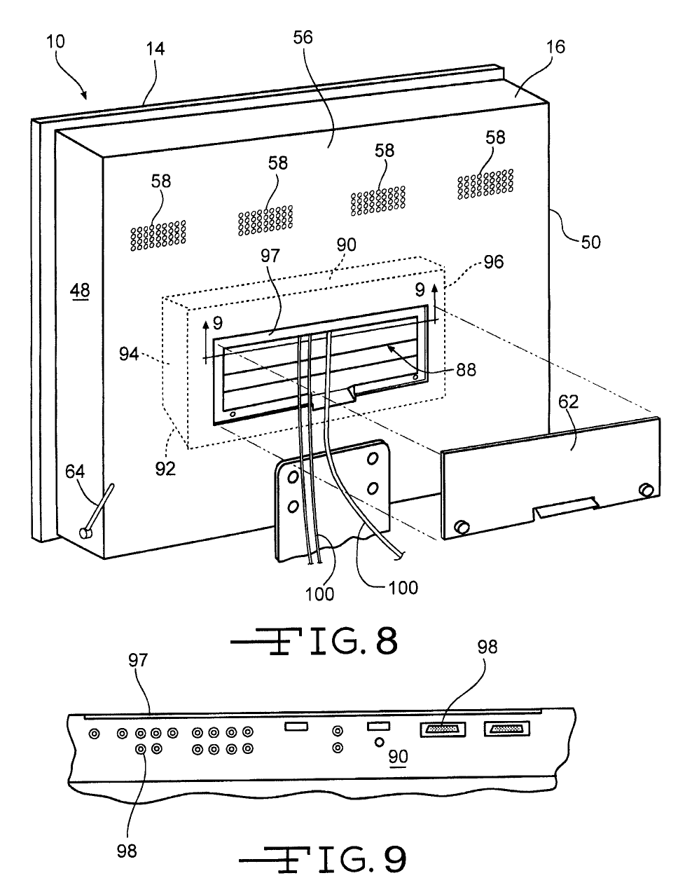

FIG. 7 is a bottom view of the display 10. The bottom surface 54 may be defined by air-inlets 76 extending through the back housing 16 into a cavity 27 (shown in FIG. 10) of the back housing 16. The air-inlets 76 may be disposed in and/or adjacent to the bottom surface 54 of the housing 12. The air-inlets 76 may comprise slotted covers 78 attached over openings 80 in the bottom surface 54. Filters 82 may cover the air-inlets 76 disposed between the slotted covers 78 and the bottom surface 54. The filters 82 may be made of a foam material, a sponge material, a fibrous material, or a mesh of material or fibers, used to trap and prevent particulates such as dust from entering the housing 12 into cavity 27. In one embodiment, the filters are made of a sponge material, manufactured by Shang Yao, of Taiwan, having product nos. 35PPI(AIRFILTER), or 30PPI(AIRFILTER). The filters 82 may be adapted to trap dust particles and moisture so as to prevent dust and moisture from entering the housing 12 through the air-inlets 76, while allowing air to enter the housing 12. Identical or similar filters may be disposed within the back housing 16 covering the air-outlets 58 in the back surface 56 (shown in FIG. 4) in order to reduce dust particles and moisture from entering the housing through the air-outlets 58. In other embodiments, the air-inlets 76 may be disposed close to the bottom surface 54. In still other embodiments, the position of the air-inlets 76 may vary.

The left and right side surfaces 48 and 50 may be angled at angles 84 and 86 towards the back surface 56. The angles 84 and 86 may extend between the plane 69 formed in the front viewing surface 15 of the front housing 12 and the left and right side surfaces 48 and 50. The angles 84 and 86 may be greater than 90 degrees. The angles 84 and 86 may be identical. In another embodiment, the angles 84 and 86 may range from 95 degrees to 170 degrees, and preferably, from 105 degrees to 160 degrees, and more preferably from 105 to 135 degrees. The angles 84 and 86 may allow for moisture to be moved away from the front viewing surface 15 towards the back surface 56 to limit moisture accumulation onto the front viewing surface 15.

FIG. 8 is a back perspective view of the display 10 with the removable panel 62 removed from the back surface 56 to expose an electrical connector cavity 88 in the back housing 16. The cavity 88 may be closed relative to an internal cavity 27 (shown in FIG. 10) of the back housing 14. As shown in FIG. 8 in dashed lines, the cavity 88 may comprise top and bottom internal opposing recessed cavity surfaces 90 and 92 and left and right internal opposing recessed cavity surfaces 94 and 96. The top, left, and/or right internal recessed cavity surfaces 90, 94, and 96 may be recessed behind an external housing surface 97. The external housing surface 97 may be integrally formed as one piece with the back surface 56 of the back housing 16. In other embodiments, the external housing surface 97 may comprise any external surface of the housing 12. The top, bottom, left, and right internal recessed cavity surfaces 90, 92, 94, and 96 may be perpendicular to the external housing surface 97. In other embodiments, the configurations of the top, bottom, left, and right internal recessed cavity surfaces 90, 92, 94, and 96 may vary.

FIG. 9 is a partial cross-sectional view through line 9-9 of FIG. 8. As shown in FIG. 9, electrical connectors 98 may be attached to the top internal recessed cavity surface 90 in order to recess the electrical connectors 98 behind the external housing surface 97. In such manner, the likelihood of the electrical connectors 98 being exposed to moisture may be reduced when the display 10 is operated in rain or snow. The electrical connectors 98 may extend through the top internal recessed cavity surface 90 into the internal cavity 27 (shown in FIG. 10) of the back housing 14 in order to connect the display 10 to one or more wires 100 running into the cavity 88 from outside the back housing 16. The one or more wires 100 may comprise power and/or signal wires connected to the display 10. In other embodiments, the electrical connectors 98 may be attached to the left and/or right internal recessed cavity surfaces 94 and 96. Electrical connectors 98 may comprise audio connectors such as RCA jacks; video connectors such as RCA jacks, HDMI connectors, DVI connectors, and HD15 type connectors; and power connectors.

FIG. 10 is a partially exploded front perspective view of the display 10. The glass panel 24 is shown aligned over the cavity 26 of the front housing 14. Shown between the front housing 14 and the back housing 16 are a liquid crystal panel 102, a brightness-enhancing diffusing film 104, and a backlight 106. The liquid crystal panel 102 may comprise an array of pixels having red, green, and blue liquid crystals. The array may have at least 100×100 pixels. Preferably, the array has 720×480 pixels. More preferably, the array has 1280×720 pixels, and more preferably the array has 1920×1080 pixels. In other embodiments, the liquid crystal panel 102 may vary. The backlight 106 may comprise a light source for illuminating the liquid crystal panel. The light source may include a compact fluorescent light, a light emitting diode, a xenon light, a halogen light, or other such light source. The backlight 106 may be adapted to output at least 1000 Nits of light, and preferably, at least 1500 Nits of light. The brightness-enhancing diffusing film 104 allows more light to pass through than a standard diffusing film, and may comprise a brightness enhancement film manufactured by 3M™ of St. Paul Minn., under the name Vikuiti™ and having the model number BEF-III 10T or DBEF-D 400. The brightness-enhancing diffusing film 104 preferably comprises a layer of polycarbonate on a layer of Vikuiti™ brightness enhancement film on another layer of polycarbonate having a thickness preferably from 300 microns to 500 microns. In other embodiments, the brightness-enhancing diffusing film 104 may vary. The brightness-enhancing diffusing film 104 may be adapted to diffuse, brighten, and enhance light 109 emitted from the backlight 106 through the brightness-enhancing diffusing film 104, through the liquid crystal panel 102, and out of the glass panel 24. As a result of the brightness-enhancing film 104, the display 10 may emit a viewing picture having a brightness of at least 1200 Nits. In other embodiments, due to the use of the brightness-enhancing film 104, the viewing picture may have a brightness in a range of 1000 to 2000 Nits.

As shown in FIG. 10, the internal cavity 27 of the back housing 16 may include air-inlets 76 (shown as hidden-lines within the bottom surface 54 of the back housing 16), air-inlet fans 110, speakers 112, an infrared repeater 114, a photocell 116, a wireless device 118, antennas 64 and 70, display controllers 74, power splitters 120, a recessed electrical connector cavity 88, electrical connectors 98, a display power circuit board 122, a PCB image circuit board 124, a fan power circuit board 126, air-outlets 58, air-outlet fans 128, a thermostat 130, and a temperature sensor 132. One or more of the display power circuit board 122, the PCB circuit image board 124, and the fan power circuit board 126 may have been coated with a weather-resistant coating 127. In one embodiment, each of the circuit boards 122, 124, and 126 may have been entirely coated with the weather-resistant coating 127. Preferably the circuit boards 122, 124, and 126 use a PCB made from silicon having a thickness of approximately 3 mm.

The weather-resistant coating 127 may comprise a polymer, an epoxy resin, or silicone. The weather-resistant coating 127 may have a thickness 129 of at least 100 microns, and preferably, at least 1 mm, and more preferably, approximately 3 mm. The weather-resistant coating 127 may have been applied to the circuit boards 122, 124, and 126 by dipping the circuit boards 122, 124, and 126 into the coating 127, or by spraying the coating 127 on the circuit boards 122, 124, and 126. The weather-resistant coating 127 may prevent the circuit boards 122, 124, and 126 from being damaged by moisture when the display 10 is operated during rain and/or snow in ambient temperatures outside the cavity 27 of down to 40 degrees below Celsius. In other embodiments, the weather-resistant coating 127 may vary, and may be applied to the circuit boards 122, 124, and 126 using varying processes, and/or may provide additional protection from moisture when the display 10 is operated in varying temperatures.

As shown in FIGS. 1 and 10, the photocell 116 disposed within the repeater/photocell opening 36 of the front housing 14 may detect an amount of ambient light 158 around the display 10. The photocell 116 may comprise any device which can detect light, and preferably includes a light sensitive resistor. The photocell 116 may have been integrated into the display 10 during manufacture of the display 10. The photocell 116 may be in communication with the backlight 106. The photocell 116 may automatically brighten the backlight 106 when an amount of ambient light 158 around the display is increased, and may automatically dim the backlight 106 when an amount of ambient light 158 around the display in decreased. The photocell 116 may automatically brighten the backlight 106 to provide a viewing picture emitted from the liquid crystal panel 102 having at least 1000 Nits of brightness when the ambient light 158 around the display is bright, such as during a sunny day. The photocell 116 may automatically dim the backlight 106 to provide a viewing picture emitted from the liquid crystal panel 102 having at least 800 Nits of brightness when the ambient light 158 around the display is dark, such as during night. In such manner, the viewing picture emitted from the liquid crystal panel 102 may be automatically regulated to provide a high-quality viewing picture during daytime and nighttime.

FIG. 11 is a cross-sectional view through line 11-11 of FIG. 1 showing the assembled arrangement of components within the internal cavity 27 of the back housing 16. All of the components within the internal cavity 27 may have been integrated into the display 10 during the original manufacturing of the display 10. The backlight 106, brightness-enhancing film 104, and liquid crystal panel 102 may be attached to one another in stacked arrangement 134 within the cavity 27. The stacked arrangement 134 may be spaced apart from the bottom surface 54, front viewing surface 15, top surface 52, and back surface 56. The stacked arrangement 134 may be disposed in parallel alignment to the front viewing surface 14 and the back surface 56. The stacked arrangement 134 may be disposed against the recessed electrical connector cavity 88.

Referring to FIGS. 10 and 11, the air-inlet fans 110 may comprise cooling fans from 40 mm to 120 mm in diameter. The air-inlet fans 110 may be positioned over and/or adjacent to the air-inlets 76. The air-outlet fans 128 may comprise cooling fans from 40 mm to 120 mm in diameter. The air-outlet fans 128 may be positioned over and/or adjacent to the air-outlets 58. The air-inlet fans 110 and air-outlet fans 128 may be positioned to move ambient air 136 to follow path 138, illustrated using arrows, from outside the housing 16, through the air-inlets 76, into the internal cavity 136, across the liquid crystal panel 102, and out of the cavity 27 back into the atmosphere 136 through the air-outlets 58. The thermostat 130 may comprise a thermostat manufactured by Texas Instruments Incorporated of Dallas, Tex. In one embodiment, the thermostat 130 comprises a heat sensitive resistor. The thermostat 130 may be in communication with the temperature sensor 132. The temperature sensor 132 may provide temperature readings within the cavity 27 to the thermostat 130.

The thermostat 130 may be in communication with the air-inlet fans 110 and air-outlet fans 128 in order to control operation of the fans 110 and 128 based on the temperature readings of the sensor 132 thereby regulating temperature within the cavity 127. When the temperature within the cavity 27 is over a set-temperature, the thermostat 130 may turn the fans 110 and 128 on to cool down the cavity 27 and the liquid crystal panel 102. As the temperature increases over the set-temperature, the thermostat 130 may increase the air-flow rates of the fans 110 and 128 to provide increased cooling within the cavity 27. When the temperature within the cavity 27 decreases below the set-temperature, the thermostat 130 may turn off the fans 110 and 128. The regulation of temperature within the cavity 27 by the thermostat 130 may allow the liquid crystal panel 102 to be operated when the ambient temperature outside the housing 12 is up to 60 degrees Celsius without visible deterioration of a viewing picture emitted from the liquid crystal panel 102. In other embodiments, the thermostat 130 may be programmed to allow operation of the liquid crystal panel 102 in varying atmospheric temperatures.

Referring to FIG. 10, the speakers 112 may be disposed in positions within the cavity 27 to be adjacent to the speaker openings 34 (shown in FIG. 1) in the front housing 14. The speakers 112 are water-resistant and may comprise a marine speaker. The speakers 112 may be outdoor weather-proof speakers adapted to be operated in rain and snow. In other embodiments, various types of weather-proof speakers 112 may be used. The power splitters 120 may split power to one or more of the liquid crystal panel 102 (shown in FIG. 11), the backlight 106 (shown in FIG. 11), the inlet fans 110, the outlet fans 128, the speakers 112, the infrared repeater 114, the photocell 116, the wireless device 118, the antennas 64 and 70, the display controllers 74, the display power-board 122, the PCB image board 124, the fan power-board 126, the thermostat 130, and the temperature sensor 132. The electrical connectors 98 may extend from the recessed electrical connector cavity 88 into the cavity 27. In such manner, the electrical connectors 98 may connect the electronic components within the internal cavity 27 to one or more power and/or signal wires 100 (shown in FIG. 9) running into the recessed cavity 88 from outside the back housing 16 in order to supply power, audio, and/or video signals to the display 10. The display power-board 122 and PCB image board 124 may power the liquid crystal panel 102 and the backlight 106. The fan power-board 126 may power the inlets fans 110 and the outlet fans 128.

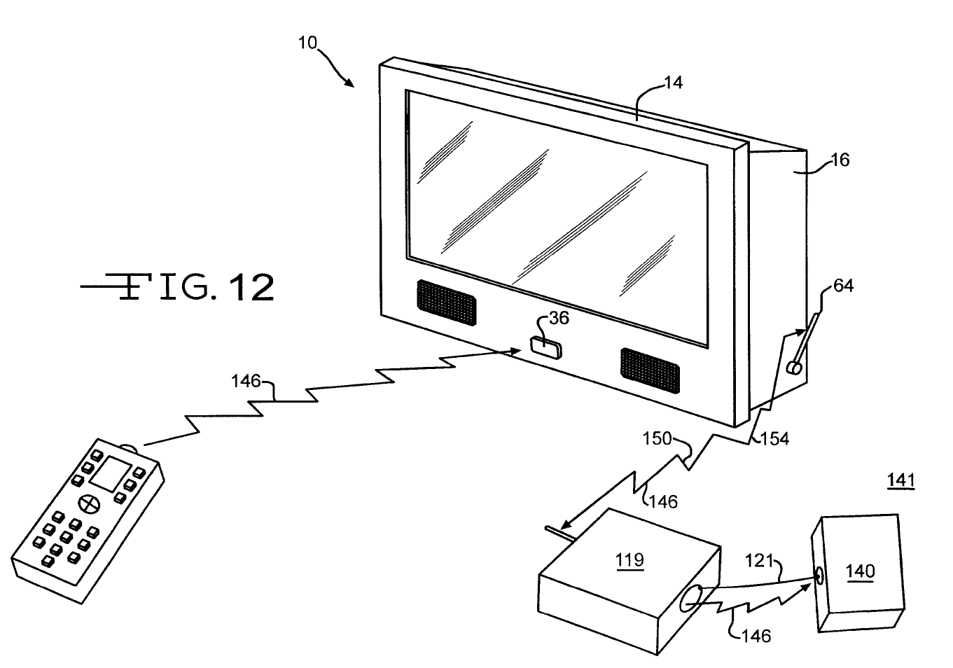

FIG. 12 is a front perspective view of the display 10 communicating with an external electronic component 140 located at a remote location 141. The external electronic device 140 may comprise a video signal device, a satellite device, a digital video disk player, a radio, a computer, and/or another type of external electronic component 140.

As shown in FIGS. 10 and 12, the display 10 receives audio and video signals from the external electronic component 140 using a remote receiver/transmitter device 119 which is connected with the external electronic component 140 and a wireless receiver 118 which is in wireless communication with the remote receiver/transmitter device 119. The wireless device 118 may comprise a receiver 152 for wirelessly receiving audio and video signals 154 transmitted from the external electronic component 140. The wireless device 118 and the remote receiver/transmitter device 119 preferably use radio frequencies to transmit the audio and video signals from the remote receiver/transmitter device 119 to the wireless device 118. The wireless device 118 may have been integrated into the display 10 during manufacture of the display 10. The remote receiver/transmitter device 119 receives audio and video signals from the external electronic component 140 through an audio and/or video cable or cables 121. The remote receiver/transmitter device 119 then converts the audio and video signals into an audio and video signal 154 which can be transmitted wirelessly between the remote receiver/transmitter device 119 and the wireless device 118. Preferably, the audio and video signal 154 is a digital signal which conforms to 802.11a, 802.11b, 802.11g, or 802.11n standards. The antennas 64 and 70 may wirelessly receive the audio and video signals 154 from the external electronic component 140, and may communicate the received audio and video signals 154 to the wireless device 118. The wireless device 118 may receive audio and video signals 154 from the external electronic component 140 at a remote location 141 which is spaced up to 100 meters away from the display 10. In one embodiment, the remote location 141 may be located at least 3 meters away from the wireless device 118. In other embodiments, the wireless device 118 may wirelessly receive audio and video signals 154 from a remote location 141 varying distances away.

The wireless device 118 may also comprise a transmitter 156 for wirelessly transmitting various types of wireless signals 150 to the external electronic component 140. The wireless device 118 may transmit the signals 150 to the external electronic component 140 using the antennas 64 and 70. The wireless device 118 may wirelessly transmit the signals 150 to the external electronic component 140 at a remote location 141 which is spaced up to 10 meters away from the display 10. In one embodiment, the external electronic component 140 may be located at least 3 meters away from the wireless device 118. In other embodiments, the wireless device 118 may wirelessly transmit varying types of signals 150 varying distances.

A user 142 may aim a remote-control 144 at the display 10. The remote-control 144 may transmit an infrared signal 146 which may be received by the infrared repeater 114 (shown also in FIG. 10) disposed in the repeater/photocell opening 36 of the front housing 14. The infrared repeater 114 may comprise a receiver 115. In one embodiment, the receiver 115 is an infrared light sensor. The infrared repeater then communicates the infrared signal 146, and particularly information within infrared signal 146, to the external electronic component 140, either through its own transmitter, or through the transmitter 156. The infrared repeater 114 may have been integrated into the display 10 during manufacture of the display 10. The infrared repeater 114 may be adapted to communicate the infrared signal 146 to the external electronic component 140 through hard-wiring 148 running between the infrared repeater 114 and the external electronic component 140. The infrared repeater 114 may also be adapted to communicate the infrared signal 146 to the external electronic component 140 using the wireless device 118 (shown in FIG. 10) within the cavity 27 to send/transmit wireless signals 150 to the external electronic component 140 without using the hard-wiring 148. The wireless device 118 within the cavity 118 may communicate the infrared signal 146 to the antennas 64 and 70 which may wirelessly communicate the infrared signal 146 to the external electronic component 140 using the wireless signals 150. Through the wireless device 118 and the antennas 64 and 70, the infrared repeater 114 may wirelessly communicate the infrared signal 146 to the external electronic component 140 at a remote location 141 which is spaced up to 10 meters away from the display 10. In one embodiment, the remote location 141 may be located at least 3 meters away from the wireless device 118. In other embodiments, the infrared repeater 114 may wirelessly communicate the infrared signal 146 varying distances.

As a result of the first and second sealants 18 and 32 securely sealing the housing 12, the weather-resistant materials and design of the display 10, the weather-resistant coating 127 covering the circuit boards 122, 124, and 126, the use of the recessed electronic connector cavity 88 separated from the internal cavity 27, and the use of the angled housing surfaces 48, 50, and 52, the outdoor weather-resistant display 10 may have an ingress protection rating of at least 56 limiting dust ingress and liquid penetration and flooding into the display 10. The weather-resistant display 10 may be able to withstand liquid sprayed directly onto the display from a high-pressure nozzle. Moreover, due to the use of the thermally conductive housing 12 to transfer heat away from the display 10, the regulation of the temperature of the internal cavity 27 of the display 10, the use of the thermostat 130 to control the fans 10 and 128, and the weather-resistant coating 127 covering the circuit boards 122, 124, and 26, the weather-resistant display 10 may be operated in all types of environments ranging from extreme cold with snow and ice accumulation in temperatures down to minus 40 degrees Celsius, to heavy rainfall, to extreme heat conditions in temperatures up to 60 degrees Celsius without damage to the display 10. Additionally, due to the use of the anti-reflective coating 26 on the glass panel 24, the use of the brightness-enhancing diffusing film 104 to provide an ultra-bright picture emitted from the liquid crystal panel 102, and the use of the photocell 116 to automatically brighten and dim the backlight 106 to accommodate for ambient light 158 conditions, the display 10 may be fully functional in varying weather. Moreover, due to the use of the infrared repeater 114, the use of the wireless device 118, and the use of the antennas 64 and 70, the display 10 may be operated wirelessly at a distance from a remote external electronic component 140.

It should be understood, of course, that the foregoing relates to exemplary embodiments of the disclosure and that modifications may be made without departing from the spirit and scope of the disclosure as set forth in the following claims.

We claim:

1. An outdoor weather-resistant display comprising:
a housing defining a cavity;
an air-inlet disposed through the housing into the cavity;
an air-outlet disposed through the housing out of the cavity;
a liquid crystal panel disposed within the cavity;
a fan positioned to move air from outside the housing, through the air-inlet, into the cavity, across the liquid crystal panel, and out of the cavity through the air-outlet to outside the housing; and
a thermostat having a temperature sensor within the cavity, wherein the temperature sensor provides temperature readings within the cavity to the thermostat, the thermostat is in communication with the fan, and the thermostat controls operation of the fan based on the temperature readings in order to regulate temperature within the cavity.

2. The outdoor weather-resistant display of claim 1 wherein the air-inlet is disposed at least one of in and adjacent to a bottom surface of the housing.

3. The outdoor weather-resistant display of claim 1 wherein at least one of the air-inlet and the air-outlet is covered by a filter.

4. The outdoor weather-resistant display of claim 3 wherein the filter comprises sponge material.

5. The outdoor weather-resistant display of claim 1 wherein the air-outlet is disposed at least one of in and adjacent to a top surface of the housing.

6. The outdoor weather-resistant display of claim 1 wherein the fan is positioned at least one of over and adjacent to the air-inlet.

7. The outdoor weather-resistant display of claim 1 wherein the fan is positioned at least one of over and adjacent to the air-outlet.

8. The outdoor weather-resistant display of claim 1 comprising a plurality of fans, at least one of the fans being disposed at least one of over and adjacent to the air-inlet, and at least one of the fans being disposed at least one of over and adjacent to the air-outlet.

9. The outdoor weather-resistant display of claim 1 wherein at least one of the air-inlet and the air-outlet comprises a plurality of openings in the housing.

10. The outdoor weather-resistant display of claim 1 wherein the fan is sized between 80 mm and 120 mm.

11. The outdoor weather-resistant display of claim 1 wherein the thermostat comprises a heat sensitive resistor.

12. The outdoor weather-resistant display of claim 1 wherein the thermostat regulation of temperature within the cavity allows the liquid crystal panel to be operated when an atmospheric temperature outside the housing is up to 140 degrees Fahrenheit without visible deterioration of a viewing picture emitted from the liquid crystal panel.

13. An outdoor weather-resistant display comprising:
a glass panel comprising a front viewing surface and a back surface;
an anti-reflective coating on the front viewing surface of the glass panel;
a liquid crystal panel disposed behind the back surface of the glass panel;
a brightness-enhancing diffusing film disposed behind the liquid crystal panel; and
a backlight disposed behind the brightness-enhancing diffusing film.

14. The outdoor weather-resistant display of claim 13 wherein the anti-reflective coating comprises SiO₂ and TiO₂.

15. The outdoor weather-resistant display of claim 13 wherein the brightness-enhancing diffusing film comprises a layer of polycarbonate.

16. The outdoor weather-resistant display of claim 13 wherein the liquid crystal panel comprises a grid of at least 1280×720 pixels.

17. The outdoor weather-resistant display of claim 13 wherein the backlight comprises a compact fluorescent light.

18. The outdoor weather-resistant display of claim 13 wherein the outdoor weather-resistant display emits a viewing picture having a brightness of at least 1,200 Nits.

19. The outdoor weather-resistant display of claim 13 further comprising a photocell in communication with the backlight for brightening the backlight when an amount of ambient light around the display is increased and dimming the backlight when the amount of ambient light around the display is decreased.

20. The outdoor weather-resistant display of claim 19 wherein the photocell comprises a light sensitive resistor.

21. An outdoor weather-resistant display comprising:
a liquid crystal panel;
a backlight disposed behind the liquid crystal panel; and
a photocell in communication with the backlight for brightening the backlight when an amount of ambient light around the display is increased and dimming the backing when the amount of ambient light around the display is decreased.

22. The outdoor weather-resistant display of claim 21 wherein the photocell brightens the backlight to provide a viewing picture having at least 1200 Nits of brightness when the ambient light around the display is bright.

23. The outdoor weather-resistant display of claim 21 wherein the photocell dims the backlight to provide 1000 Nits of brightness when the ambient light around the display is dark.

24. The outdoor weather-resistant display of claim 21 further comprising a housing having a cavity, wherein the liquid crystal panel, the backlight, and the photocell are disposed within the cavity.

25. The outdoor weather-resistant display of claim 21 wherein the photocell was integrated into the outdoor weather-resistant display during manufacture of the display.

26. The outdoor weather-resistant display of claim 21 wherein the backlight comprises a compact fluorescent light.

27. The outdoor weather-resistant display of claim 21 wherein the photocell comprises a light sensitive resistor.

28. The outdoor weather-resistant display of claim 21 wherein the photocell automatically brightens and dims the backlight.

29. An outdoor weather-resistant display comprising:
a liquid crystal panel; and
an infrared repeater for receiving an infrared signal and communicating the infrared signal to an external electronic component at a remote location.

30. The outdoor weather-resistant display of claim 29 further comprising a housing having a cavity, wherein the liquid crystal panel and the infrared repeater are disposed within the cavity.

31. The outdoor weather-resistant display of claim 29 wherein the infrared repeater is hard-wired to the external electronic component.

32. The outdoor weather-resistant display of claim 29 further comprising a wireless device in communication with the infrared repeater, wherein the wireless device comprises a transmitter which wirelessly communicates the infrared signal to the external electronic component.

33. The outdoor weather-resistant display of claim 32 further comprising an antenna in communication with the wireless device, wherein the wireless device wirelessly communicates the infrared signal to the external electronic component using the antenna.

34. The outdoor weather-resistant display of claim 33 wherein the infrared repeater wirelessly communicates the infrared signal, using the wireless device and the antenna, to the external electronic component located at least 3 meters away from the infrared repeater.

35. The outdoor weather-resistant display of claim 29 wherein the infrared repeater receives the infrared signal from a remote control.

36. The outdoor weather-resistant display of claim 29 wherein the infrared repeater communicates the infrared signal to the external electronic component comprising at least one of a video signal device, a satellite device, a digital video disk player, a radio, and a computer.

37. The outdoor weather-resistant display of claim 29 wherein the infrared repeater comprises an infrared light sensor.

38. The outdoor weather-resistant display of claim 29 wherein the infrared repeater was integrated into the outdoor weather-resistant display during manufacture of the display.

39. An outdoor weather-resistant display comprising:
a housing made of a metal having a thermal conductivity of at least 200 W/mK; and
a liquid crystal panel disposed within a cavity of the housing.

40. The outdoor weather-resistant display of claim 39 wherein the metal comprises powder-coated Aluminum.

41. The outdoor weather-resistant display of claim 39 wherein a glass panel is disposed over the liquid crystal panel and an anti-reflective coating is disposed on a front viewing surface of the glass panel.

42. The outdoor weather-resistant display of claim 39 wherein the anti-reflective coating comprises SiO₂ and TiO₂.

43. The outdoor weather-resistant display of claim 39 wherein the housing was made using a metal having a thermal conductivity of at least 200 W/mK.

44. An outdoor weather-resistant display comprising:
a liquid crystal panel; and
a wireless device comprising a receiver for wirelessly receiving audio and video signals transmitted from an external electronic component.

45. The outdoor weather-resistant display of claim 44 further comprising a housing, wherein the liquid crystal panel and the wireless device are disposed within a cavity of the housing.

46. The outdoor weather-resistant display of claim 44 further comprising an antenna in communication with the wireless device, wherein the antenna wirelessly receives the audio and video signals from the external electronic component and communicates the audio and video signals to the wireless device.

47. The outdoor weather-resistant display of claim 46 wherein the wireless device receives signals from the external electronic component located at least 3 meters away from the wireless device.

48. The outdoor weather-resistant display of claim 46 further comprising a housing, wherein the liquid crystal panel and the wireless box are disposed within a cavity of the housing, and the antenna is attached to the housing.

49. The outdoor weather-resistant display of claim 44 wherein the wireless device further comprises a transmitter for wirelessly transmitting signals to the external electronic component.

50. The outdoor weather-resistant display of claim 49 further comprising an infrared repeater, wherein the infrared repeater is for receiving an infrared signal and communicating the infrared signal to the wireless device for transmission of the infrared signal to the external electronic component.

51. The outdoor weather-resistant display of claim 50 further comprising an antenna in communication with the wireless device for transmitting the infrared signal from the infrared repeater to the external electronic component.

52. The outdoor weather-resistant display of claim 51 wherein the wireless device transmits the infrared signal from the infrared repeater to the external electronic component located at least three meters away from the wireless device.

53. The outdoor weather-resistant display of claim 44 wherein the wireless device is able to transmit a radio frequency signal.

54. The outdoor weather-resistant display of claim 44 wherein the wireless device was integrated into the outdoor weather-resistant display during manufacture of the display.

55. The outdoor weather-resistant display of claim 44 wherein the receiver wirelessly receives audio and video signals transmitted from the external electronic component comprising at least one of a video signal device, a satellite device, a digital video disk player, a radio, and a computer.

56. An outdoor weather-resistant display comprising:
a housing defining a cavity;
a liquid crystal panel disposed within the cavity; and
a circuit board disposed within the cavity, wherein the circuit board is coated with a weather-resistant coating.

57. The outdoor weather-resistant display of claim 56 wherein the entire circuit board is coated with the weather-resistant coating.

58. The outdoor weather-resistant display of claim 56 wherein the weather-resistant coating comprises silicone.

59. The outdoor weather-resistant display of claim 56 wherein the weather-resistant coating has a thickness of at least 100 microns.

60. The outdoor weather-resistant display of claim 56 wherein the weather-resistant coating prevents the circuit board from being damaged by moisture when the display is operated in temperatures down to 40 degrees below Fahrenheit.

61. An outdoor weather-resistant display comprising:
a housing defining a cavity, wherein the housing comprises a front viewing surface and an opposing back surface, a top surface and an opposing bottom surface, and two side surfaces, wherein the top surface, the bottom surface, and the two side surfaces extend between the front viewing surface and the back surface, wherein at least one of the top surface and the two side surfaces is angled towards the back surface at an angle of more than 90 degrees relative to a plane extending through the front viewing surface in order to move moisture away from the front viewing surface; and
a liquid crystal panel disposed within the cavity.

62. The outdoor weather-resistant display of claim 61 wherein the angle falls within a range of 105 degrees to 160 degrees.

63. The outdoor weather-resistant display of claim 61 wherein each of the top surface and the two side surfaces are angled towards the back surface at an angle of more than 90 degrees relative to the plane extending through the front viewing surface.

64. The outdoor weather-resistant display of claim 61 wherein the housing is made of a metal having a thermal conductivity of at least 200 W/mK.

65. The outdoor weather-resistant display of claim 64 wherein the metal comprises powder coated Aluminum.

66. An outdoor weather-resistant display comprising:
a housing comprising an external housing surface, wherein a first cavity is defined in the external housing surface, wherein the first cavity comprises an internal cavity surface which is recessed behind the external housing surface;
an electrical connector disposed on the internal recessed cavity surface;
a removable panel for covering the first cavity; and
a liquid crystal panel disposed within a second cavity of the housing.

67. The outdoor weather-resistant display of claim 66 wherein the first cavity is closed relative to the second cavity.

68. The outdoor weather-resistant display of claim 66 wherein the internal cavity surface comprises a top surface of the first cavity.

69. The outdoor weather-resistant display of claim 66 wherein the internal cavity surface comprises a side surface of the first cavity.

70. The outdoor weather-resistant display of claim 66 wherein the internal cavity surface is disposed perpendicular to the external housing surface.

71. The outdoor weather-resistant display of claim 66 wherein the housing comprises a front viewing surface and an opposed back surface, and the external housing surface comprises the opposed back surface.

72. The outdoor weather-resistant display of claim 66 wherein the electrical connector extends between the first and second cavities and allows for an electrical connection to be made within the second cavity.

73. The outdoor weather-resistant display of claim 66 wherein the electrical connector connects the liquid crystal panel to at least one of a power and a signal wire extending into the first cavity from outside the housing.

74. The outdoor weather-resistant display of claim 66 wherein the recessed internal cavity surface prevents the electrical connector from being exposed to moisture when the display is operated in at least one of rain and snow.

75. An outdoor weather-resistant display comprising:
a front housing sealed to a back housing with a first sealant, wherein a cavity is defined within the front and back sealed housings;
a liquid crystal panel disposed within the cavity;
a fan positioned to move air from outside the front and back sealed housings, through an air-inlet, into the cavity, across the liquid crystal panel, and out of the cavity to outside the front and back sealed housings;
a thermostat having a temperature sensor within the cavity, wherein the temperature sensor provides temperature readings within the cavity to the thermostat, the thermostat is in communication with the fan, and the thermostat controls operation of the fan based on the temperature readings in order to regulate temperature within the cavity;
a glass panel covering the cavity, the glass panel sealed to the front housing with a second sealant; and
a circuit board disposed within the cavity, wherein the circuit board is coated with a weather-resistant coating.

76. The outdoor weather-resistant display of claim 75 wherein the first sealant comprises a rubber gasket.

77. The outdoor weather-resistant display of claim 75 wherein the second sealant comprises silicone.

78. The outdoor weather-resistant display of claim 75 wherein the weather-resistant coating comprises silicone.

79. The outdoor weather-resistant display of claim 75 wherein the outdoor weather-resistant display has an ingress protection rating of at least 56 limiting dust ingress into the display and limiting liquid penetration and flooding into the display.

80. The outdoor weather-resistant display of claim 75 wherein the front housing comprises a front viewing surface and the back housing comprises a top surface, two side surfaces, a bottom surface, and a back surface, wherein at least one of the top surface and the two side surfaces is angled towards the back surface at an angle of more than 90 degrees relative to a plane extending through the front viewing surface in order to move moisture away from the front viewing surface.

81. The outdoor weather-resistant display of claim 80 wherein the angle falls within a range of 105 degrees to 160 degrees.

82. The outdoor weather-resistant display of claim 80 wherein each of the top surface and the two side surfaces are angled towards the back surface at an angle of more than 90 degrees relative to the plane extending through the front viewing surface.

83. The outdoor weather-resistant display of claim 75 wherein another cavity is defined in an external surface of the housing, the another cavity comprises an internal cavity surface which is recessed behind the external surface, an electrical connector is disposed on the internal cavity surface, and a removable panel covers the another cavity.

84. The outdoor weather-resistant display of claim 83 wherein the internal cavity surface is disposed perpendicular to the external housing surface.

85. The outdoor weather-resistant display of claim 83 wherein the electrical connector connects the display to at least one of a power and a signal wire running into the another cavity from outside the housing.

86. The outdoor weather-resistant display of claim 83 wherein the electrical connector extends between the cavity and the another cavity to provide an electrical connection within the cavity.

87. The outdoor weather-resistant display of claim 75 wherein the thermostat regulation of temperature within the cavity allows the liquid crystal panel to be operated when an atmospheric temperature outside the housing is up to 140 degrees Fahrenheit without visible deterioration of a viewing picture emitted from the liquid crystal panel.

88. The outdoor weather-resistant display of claim 75 wherein the weather resistant coating prevents the circuit board from being damaged by moisture when the display is operated in temperatures down to 40 degrees below Fahrenheit.
